(19) United States
(12) Patent Application Publication
(10) Pub. No.: US 2016/0262450 A1
(43) Pub. Date: Sep. 15, 2016

(54) BATTERY ASSEMBLY, ELECTRONIC CIGARETTE AND METHOD FOR MANUFACTURING ELECTRONIC CIGARETTE

(71) Applicant: KIMREE HI-TECH INC., Tortola (VG)

(72) Inventor: Qiuming Liu, Shenzhen, Guangdong (CN)

(21) Appl. No.: 15/031,268

(22) PCT Filed: Mar. 13, 2014
(86) PCT No.: PCT/CN2014/073392

§ 371 Date: Apr. 21, 2016

(51) Int. Cl. A24F 47/00; H01M 2/04; H01M 2/02

(52) U.S. Cl. CPC A24F 47/002; H01M 2/022; H01M 2/026; H01M 2/0277; H01M 2/0404; H01M 2/046; H01M 2/0482; H01M 2002/0297

(57) ABSTRACT

This present application relates to a battery assembly, an electronic cigarette, and a method for manufacturing the electronic cigarette, the battery assembly comprises a main body emitting light in an operating state, and a cover arranged on one end of the main body, wherein the cover is a light transmission body of a solid structure; the cover is oppositely provided with an internal end surface facing the main body and an external end surface exposed outside the main body; and a pattern layer is arranged on the internal end surface; a vent groove configured for connecting an internal of the main body with the external air is defined on a peripheral surface of the cover. In this way, the pattern layer can be not easily to get worn and scratched, and when the electronic cigarette is in use, the cover is not easy to shake and cause sharp noises.

### TECHNICAL FIELD

The present application relates to the field of electrical products, and more particularly to an electronic cigarette and a method for manufacturing the electronic cigarette.

### BACKGROUND

In the prior art, an electronic cigarette comprises atomizer assemblies and battery assemblies connected with the atomizer assemblies. The battery assembly includes a main body and a cover arranged at an end of the main body, with a vent groove defined on the cover. Generally, the cover is provided with a cylindrical thin shell structure with an open at one end. When the electronic cigarette is in use, an airflow entering into the battery assembly from the vent groove, can impact against the cover in the thin-shell shape, which easily causes the cover to shake to further result in a sharp noise, thus damaging real cigarette simulating effects of the electronic cigarette. In addition, a pattern layer is arranged on an external surface of the cover of the electronic cigarette in the prior art, in order that a pattern will appear when lights emits out through the cover. However, the pattern layer configured on the external surface of the cover is easily to get scratched and worn.

### SUMMARY

Aiming at the drawbacks in the prior art that the pattern layer of an electronic cigarette is easy to be scratched and worn, and the cover of the electronic cigarette is easy to shake to cause a sharp noise, the objective of the present application is to provide a battery assembly, an electronic cigarette equipped with the battery assembly, and a method for manufacturing the electronic cigarette, wherein, the battery assembly facilitate the arrangement of the pattern layer, which is not easy to be worn, and can be avoided the cover from shaking to cause sharp noises.

In order to realize the objective mentioned above, in one aspect, a battery assembly is provided, which comprises a main body emitting lights in working status and a cover arranged at one end of the main body, wherein, the cover is a light transmission body with a solid structure; the cover is oppositely provided with an internal end surface facing the main body and an external end surface exposed outside the main body, and a pattern layer is arranged on the internal end surface; a vent groove configured for communicating an internal of the main body with the external air is defined on a peripheral surface of the cover.

In one embodiment, the internal end surface of the cover is a flat surface, and the pattern layer is arranged on the flat surface.

In this embodiment, the main body is sleeved with an outer thimble, and the cover is integrated with the outer thimble.

In this embodiment, the cover and the main body are configured to be mounted separately; the cover includes an inserting portion inserted into the main body, the pattern layer is arranged on the inserting portion.

In another embodiment, the cover and the main body are configured to be mounted separately; the battery assembly further includes a connection portion inserted into the main body, and the cover is connected to the main body via connecting to the connection portion.

In this embodiment, the connection portion is barrel shaped, and the connection portion is connected to the cover via welding.

In yet another embodiment, the connection portion is barrel shaped, and an adhesive layer configured for sticking the cover with the connection portion is arranged on an end surface of the connection portion.

In this embodiment, the cover is made from any one of polycarbonate, polystyrene, and polymethyl methacrylate.

In this embodiment, the pattern layer is a stereoscopic emboss portion forming on the internal end surface, and the stereoscopic emboss portion includes concave-convex patterns and texts.

In this embodiment, a lamp is mounted corresponding to the cover in the main body; wherein a battery is mounted in the main body, and the lamp is electrically connected to the battery.

In another aspect, this present application further provides an electronic cigarette comprising a battery assembly and an atomizer assembly that are connected to each other, wherein, the battery assembly includes a main body emitting lights in working status and a cover arranged at one end of the main body, wherein, the cover is a light transmission body with a solid structure; the cover is oppositely provided with an internal end surface facing the main body and an external end surface exposed outside the main body, and a pattern layer is arranged on the internal end surface; a vent groove configured for communicating an internal of the main body with the external air is defined on a peripheral surface of the cover.

In this embodiment, the internal end surface of the cover is a flat surface, and the pattern layer is arranged on the flat surface.

In this embodiment, the cover is provided with a solid structure.

In this embodiment, the main body includes an outer thimble, and the cover is integrated with the outer thimble.

In this embodiment, the cover and the main body are configured to be mounted separately; the cover includes an inserting portion inserted into the main body, on which the pattern layer is arranged.

In another embodiment, the cover and the main body are configured to be mounted separately; the battery assembly further includes a connection portion inserted into the main body, and the cover is connected to the main body via connecting to the connection portion.

In this embodiment, the connection portion is barrel shaped, and the connection portion is connected to the cover via welding.

In yet another embodiment, the connection portion is barrel shaped, and an adhesive layer configured for sticking the cover with the connection portion is arranged on an end surface of the connection portion.

In yet another aspect, this present application further provides a method for manufacturing the electronic cigarette described above-mentioned, and the method comprises several steps as follow:

Step 1: respectively producing the main body and the cover with an internal end surface of which the pattern layer is provided, mounting a lamp in the main body corresponding to the cover, wherein the lamp is connected to a battery mounted in the main body, and further arranging the cover on one end of the main body to form the battery assembly;

or producing the cover and the outer thimble via integrating them with each other, meanwhile, forming the pattern layer at one end of the cover close to the lamp via injection molding, and further mounting a battery and electronic components in the outer thimble to form the batter assembly;

Step 2: defining a vent groove on a peripheral surface of the cover along an axial direction of a peripheral surface of the connection portion to communicate with the internal of the main body and external air;

Step 3: arranging the atomizer assembly on the other end of the main body to form the whole electronic cigarette.

By implementing the electronic cigarette and the method for manufacturing the electronic cigarette of the present application, the following advantages can be achieved: by means of arranging the pattern layer on the internal end surface of the cover, it can be ensured that not only the pattern of the pattern layer can be observed from an external of the cover during the light is transmitted, but also the pattern layer can be not easily to get worn and scratched. In addition, by means of providing the cover 2 with a solid structure, when the electronic cigarette is in use, the cover 2 is not easy to shake and thus avoid causing sharp noises due to the airflow impact, the real cigarette simulated effects of the electronic cigarette becomes better, and thus user experience is improved.

### BRIEF DESCRIPTION OF THE DRAWINGS

The present application will be further described with reference to the accompanying drawings and embodiments in the following, in the accompanying drawings:

FIG. 1 is a partial cut-away view of an electronic cigarette of a preferred embodiment of the present application;

FIG. 2 is a schematic view of a cover shown in FIG. 1;

FIG. 3 is a partial cut-away view of an electronic cigarette of a further preferred embodiment of the present application;

FIG. 4 is a whole schematic view of the status shown in FIG. 3 that a cover is being connected to a connection portion;

FIG. 5 is a decomposition schematic view of the cover and the connection portion shown in FIG. 4.

### DETAILED DESCRIPTION OF THE PREFERRED EMBODIMENT

In order to solve the problem that a pattern layer of an electronic cigarette in the prior art is easily to get worn and a cover in shape of thin shell is easy to be shake due to an airflow impact when the electronic cigarette is in use, the pattern layer 21 is arranged on an internal end surface of the cover 2 to keep the pattern layer 21 be not to get easily worn and scratched, and meanwhile the cover 2 is provided with a solid structure, in which case, the cover 2 is not easy to shake to further avoid causing sharp noises, the simulated effects of the electronic cigarette becomes better, and user experience is improved.

In order to explain the purpose, the technical features, and the effect of the present application more clearly, the specific embodiments of the present application will be described in detail referring to the drawings. It will be understood that the specific embodiments described here are merely used to explain the present application rather than a limit.

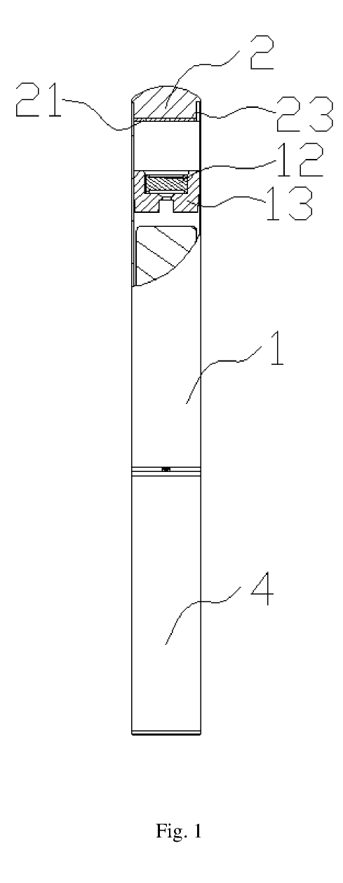

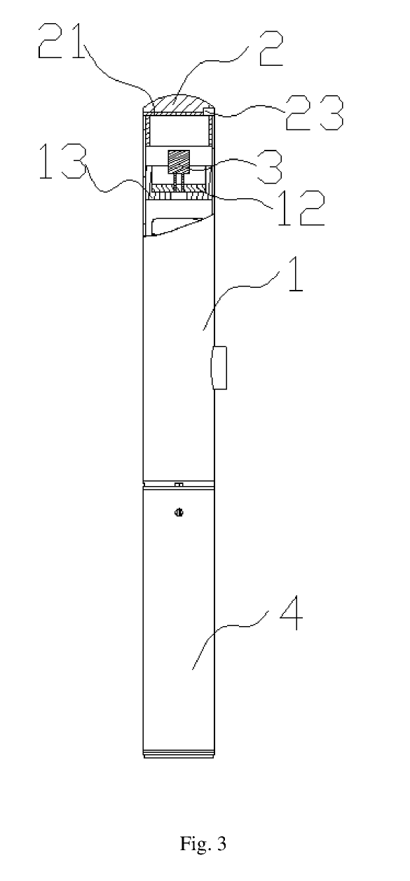

Referring to FIG. 1 and FIG. 3, the present application provides a battery assembly comprising a main body 1 emitting lights in working status and a cover 2 arranged at one end of the main body 1. The cover 2 is a light transmission body with a solid structure. The cover 2 is oppositely provided with an internal end surface facing the main body 1 and an external end surface exposed outside the main body 1, and a pattern layer 21 is arranged on the internal end surface. Lights in the main body 1 are capable to transmit to show a pattern of the pattern layer 21 to the external end surface of the cover 2.

It can be understood that since the pattern layer 21 described above is arranged on the internal end surface of the cover 2, the pattern of the pattern layer 21 can be observed from an external of the cover 2 when the light is transmitted, and the pattern layer 21 can also be not easily to get worn and scratched.

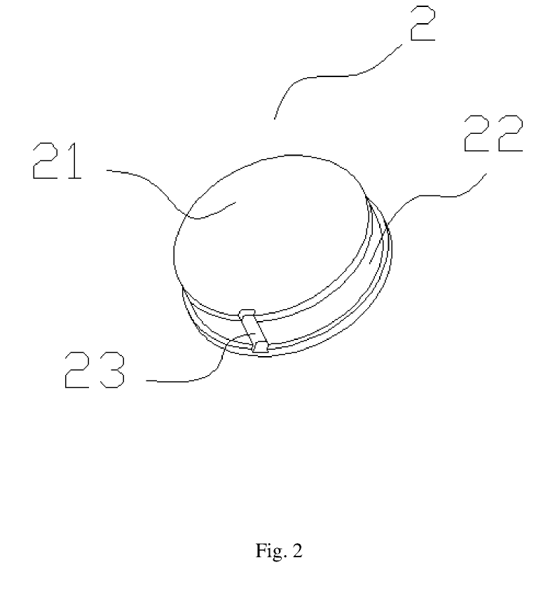

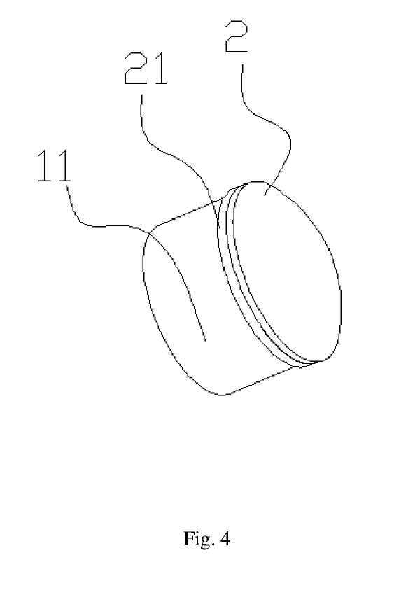

Referring to FIG. 2 and FIG. 4, preferably, in order to arrange the pattern layer 21, the internal end surface is a flat surface, and the pattern layer 21 is arranged on the flat surface.

It can be understood that the end of the cover 2 where the pattern layer 21 is arranged, does not limit to the flat surface described above, while the end where the pattern layer 21 is arranged can also be a cambered surface, and the pattern layer 21 is arranged on a top of the cambered surface. A radian range of the cambered surface is from 15° to 45°, preferably, the radian of the cambered surface is 30°. Or the end of the cover 2 where the pattern layer 21 is arranged can be defined to form a recess configured for exactly accommodating the pattern layer 21 and the pattern layer 21 is embedded in the recess.

Referring to FIG. 2 and FIG. 3, several vent grooves 23 are defined on a peripheral surface of the cover 2, configured for communicating an internal of the main body 1 with the external air. When the electronic cigarette is in use, the external air enters into the internal of the main body 1 through the vent grooves 23 described above. The number of the vent grooves 23 is not particularly restricted. Preferably, the number of the vent grooves 23 is two, the two vent grooves are evenly distributed on the peripheral surface of the cover 2, and a sectional area of each vent groove 23 is 0.3 mm² to 1 mm².

In order to prevent from occurring the situation that, when an airflow enters into the internal of the main body 1 through the vent groove 23, the cover 2 is impacted by the airflow to easily shake or cause noises, preferably, the cover is provided with the solid structure aforementioned. In order to improve shockproof or noise-canceling effects, a preferred thickness range of the cover 2 is from 2 mm to 7 mm. More preferably, the thickness of the cover 2 is 5 mm.

Specifically, the mounted means of both the cover 2 and the main body 1 are illustrated by several embodiments as follow.

A first preferred embodiment is provided that the main body 1 is sleeved with an outer thimble, and the outer thimble is integrated with the cover 2 (not illustrated).

It can be understood that the pattern layer 21 can include a concave-convex pattern and stereoscopic emboss portions and texts forming on the internal end surface of the cover 2, or the pattern layer 21 can be a platy structural body with a printed pattern on it.

In this embodiment, to facilitate manufacture, the pattern layer 21 is formed via injection molding. Preferably, the pattern layer 21 is a stereoscopic emboss portion with a concave-convex text and a pattern.

A second preferred embodiment is provided that the cover 2 and the main body 1 are configured to be mounted separately. The second preferred embodiment is the same as the first preferred embodiment that the pattern layer 21 can include a concave-convex pattern and stereoscopic emboss portions and texts forming on the internal end surface of the cover 2, or the pattern layer 21 can be a platy structural body with a printed pattern on it. Since the main body 1 and the cover 2 are configured to be arranged separately in this embodiment, in order to mount the main body 1 and the cover 2, preferably, the pattern layer 21 is chosen to be the platy structural body with the printed pattern on it.

When the cover 2 is connected to the main body 1, two connection means between the cover 2 and the main body 1 are illustrated as follow.

Referring to FIG. 1 and FIG. 2, one of the two connection means is that the cover 2 includes an inserting portion 22 inserted in the internal of the main body 1, and the pattern layer 21 is arranged on the inserting portion 22.

It can be understood that, in order to ensure the air impermeability and a tightness connection between the cover 2 and the main body 1, the inserting portion 22 is inserted into the internal of the main body 1 via interference fit.

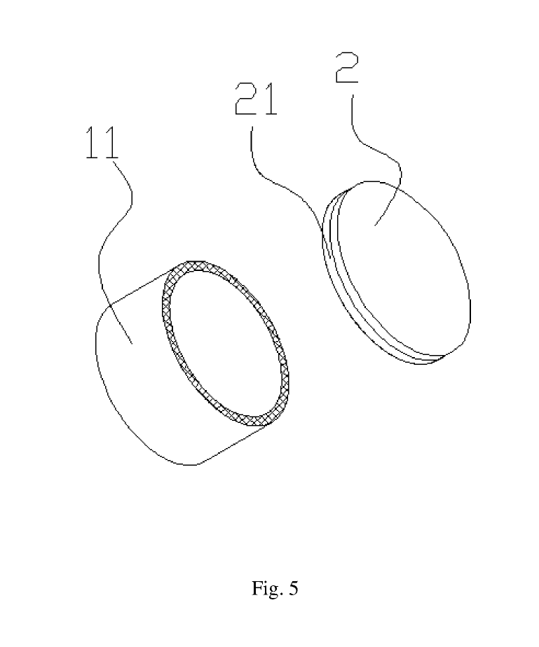

Referring to FIG. 3, FIG. 4, and FIG. 5, a third embodiment provides the other of the two connection means that the main body 1 includes a connection portion 11 configured for connecting the cover 2 to the main body 1, and the connection portion 11 is inserted in the internal of the main body 1. The cover 2 is connected to the main body 1 by means of connecting to the connection portion 11. This connection mean is the same as the one connection mean described above that the connection portion 11 is inserted in the main body 1 via interference fit.

Referring to FIG. 3 and FIG. 5, in the other connection mean, the connection portion 11 is barrel shaped, and an end surface of the connection portion 11 is welded with the cover 2. Or perhaps the connection portion 11 is barrel shaped, an adhesive layer is arranged on the end surface of the connection portion 11 configured for sticking the cover 2 with the connection portion 11. The cover 2 is connected to the connection portion 11 via the adhesive layer. It can be understood that the cover 2 can also be connected to the connection portion 11 via hot melting or other means.

In the three embodiments described above, the cover 2 is a light transmitting member. Specifically, the cover 2 is made from any one of polycarbonate, polystyrene, and polymethyl methacrylate.

In addition, referring to FIG. 1 and FIG. 3, a control unit 12 is provided at one end of the main body 1 close to the cover 2, and a mounting base is mounted in the main body 1. The control unit 12 is tightly mounted into the main body 1 via inserting into the mounting base 13 by interference fit.

A lamp 3 is mounted on one end of the control unit 12 close to the cover 2. Lights from the lamp 3 transmits through both the pattern layer 21 and the cover 2, which enables that a pattern of the pattern layer 21 can be observed outside the cover 2. Preferably, the lamp 3 is a LED lamp.

In order that the light ray of the lamp 3 can transmit through the cover 2 widespread, preferably, the external end surface of the cover 2 is chosen to be in cambered shape.

The present application further provides an electronic cigarette comprising a battery assembly and an atomizer assembly 4. The battery assembly includes a main body 1 emitting lights in working status and a cover 2 arranged at one end of the main body 1. The cover 2 is a light transmission body with a solid structure. The cover 2 is oppositely provided with an internal end surface facing the main body 1 and an external end surface exposed outside the main body 1, and a pattern layer 21 is arranged on the internal end surface. Lights in the main body 1 are capable to transmit to show a pattern of the pattern layer 21 to the external end surface of the cover 2.

The atomizer assembly 4 of the electronic cigarette belongs to a prior art, and the battery assembly of the electronic cigarette is just that described above, thus neither the atomizer assembly 4 nor the battery assembly of the electronic cigarette are explained any more herein.

The present application further provides a method for manufacturing the electronic cigarette described above comprising several steps as follow.

In step 1, the main body 1 and the cover 2 are produced, and the pattern layer 21 is provided on the internal end surface of the cover 2. Herein, the cover 2 is a solid light transmission body, the lamp 3 is mounted in the main body 1 corresponding to the cover 2, and the lamp 3 is connected to a battery mounted in the main body 1. Further, the cover 2 is mounted at one end of the main body 1 to form the battery assembly, or the cover 2 and the main body 1 can also be produced via integrating with each other; meanwhile, one end of the cover 2 being close to the lamp 3 forms the pattern layer 21 by injection molding. Besides, the battery and electronic components are mounted in the outer thimble to form the batter assembly.

In step 2, the vent groove 23 is defined on the peripheral surface of the cover 2. The vent groove 23 runs through along an axial direction of a peripheral surface of the connection portion 11; one end of the vent groove 23 communicates with an internal of the main body 1, and the other end of the vent groove 23 communicates with an external of the main body 1.

In step 3, the atomizer assembly is mounted on the other end of the main body 1 to form the whole electronic cigarette.

In Step 1, referring to FIG. 1, when the cover 2 and the main body 1 are configured to be mounted separately, the cover 2 includes a inserting portion 22 inserted in the main body 1, and the pattern layer 21 is arranged on one end surface of the inserting portion 22 that is close to the lamp 3.

Or in other cases, instead, in Step 1, referring to FIG. 3, when the cover 2 and the main body 1 are configured to be mounted separately, the main body 1 further includes a connection portion 11 configured for connecting the cover 2 to the main body 1. The connecting portion 11 is inserted in the main body 1, and the cover 2 is connected to the main body 1 via connecting to the connection portion 11.

In addition, in order to mount the pattern layer 21, an internal end surface of the cover 2 is a plat surface, and the pattern layer 21 is mounted on the plat surface.

Furthermore, in order to prevent from occurring the situation that, when an airflow enters into the internal of the main body 1 through the vent groove 23, the cover 2 is impacted by the airflow to easily shake or cause noises, preferably, the cover is provided with the solid structure. In order to improve shockproof or noise-canceling effects, a preferred thickness range of the cover 2 is from 2 mm to 7 mm. More preferably, the thickness of the cover 2 is 5 mm.

To sum up, by means of arranging the pattern layer 21 on the internal end surface of the cover 2, it can be ensured that not only the pattern of the pattern layer 21 can be observed from an external of the cover 2 when the light is transmitted, but also the pattern layer 21 can be not easily worn and scratched. In addition, by means that the cover 2 is made to be a solid structure, when the electronic cigarette is being smoked, the cover 2 is not easy to shake and cause sharp noises by impact of the airflow.

The present application has been described with the drawings to the embodiments, while the present application is not limit to the aforementioned specific embodiments and the specific embodiments are merely a hint rather than a limit. It will be understood by those skilled in the art that various changes may be made and equivalents may be substituted without departing from the purpose of the application and the scope of the claims, but all the changes will be included within the scope of the appended claims.

1-19. (canceled)

20. A battery assembly comprising a main body emitting lights in working status and a cover arranged at one end of the main body, wherein the cover is a light transmission body with a solid structure, a thickness of the cover is range from 2 mm to 7 mm; the cover is oppositely provided with an internal end surface facing the main body and an external end surface exposed outside the main body;
wherein a pattern layer is arranged on the internal end surface; at least two vent grooves configured for communicating an internal of the main body with external air are defined on a peripheral surface of the cover, the two vent grooves are evenly distributed on the peripheral surface of the cover;
wherein a sectional area of each vent groove is 0.3 mm² to 1 mm².

21. The battery assembly of claim 20, wherein the internal end surface of the cover is a flat surface, and the pattern layer is arranged on the flat surface.

22. The battery assembly of claim 20, wherein the main body is sleeved with an outer thimble, and the cover is integrated with the outer thimble.

23. The battery assembly of claim 20, wherein the cover and the main body are configured to be mounted separately; the cover includes an inserting portion inserted into the main body, and the pattern layer is arranged on the inserting portion.

24. The battery assembly of claim 20, wherein the cover and the main body are configured to be mounted separately; the battery assembly further includes a connection portion inserted into the main body, and the cover is connected to the main body via connecting to the connection portion.

25. The battery assembly of claim 24, wherein the connection portion is barrel shaped, and the connection portion is connected to the cover via welding.

26. The battery assembly of claim 24, wherein the connection portion is barrel-shaped, and an adhesive layer configured for sticking the cover with the connection portion is arranged on an end surface of the connection portion.

27. The battery assembly of claim 20, wherein the cover is made from any one of polycarbonate, polystyrene, and polymethyl methacrylate.

28. The battery assembly of claim 20, wherein the pattern layer is a stereoscopic emboss portion forming on the internal end surface, and the stereoscopic emboss portion includes concave-convex pattern and texts.

29. The battery assembly of claim 20, wherein a lamp is mounted corresponding to the cover in the main body; wherein a battery is mounted in the main body, and the lamp is electrically connected to the battery.

30. An electronic cigarette comprising a battery assembly and an atomizer assembly that are connected to each other, wherein, the battery assembly includes a main body emitting lights in working status and a cover arranged at one end of the main body, wherein, the cover is a light transmission body with a solid structure, a thickness of the cover is range from 2 mm to 7 mm; the cover is oppositely provided with an internal end surface facing the main body and an external end surface exposed outside the main body, and a pattern layer is arranged on the internal end surface; a vent groove configured for communicating an internal of the main body with external air is defined on a peripheral surface of the cover; and
wherein a sectional area of each vent groove is 0.3 mm² to 1 mm².

31. The electronic cigarette of claim 30, wherein the internal end surface of the cover is a flat surface, and the pattern layer is arranged on the flat surface.

32. The electronic cigarette of claim 31, wherein the main body includes an outer thimble, and the cover is integrated with the outer thimble.

33. The electronic cigarette of claim 30, wherein the cover and the main body are configured to be mounted separately; the cover includes an inserting portion inserted into the main body, the pattern layer is arranged on the inserting portion.

34. The electronic cigarette of claim 30, wherein the cover and the main body are configured to be mounted separately; the battery assembly further includes a connection portion inserted into the main body, and the cover is connected to the main body via connecting to the connection portion.

35. The electronic cigarette of claim 34, wherein the connection portion is barrel shaped, and the connection portion is connected to the cover via welding.

36. The electronic cigarette of claim 35, wherein the connection portion is barrel shaped, and an adhesive layer configured for sticking the cover with the connection portion is arranged on an end surface of the connection portion.
